(19) United States
(12) Patent Application Publication
(10) Pub. No.: US 2013/0226643 A1
(43) Pub. Date: Aug. 29, 2013

(54) OPERATION MANAGEMENT APPARATUS AND SORTING SYSTEM WITH OPERATION MANAGEMENT APPARATUS

(71) Applicant: Daifuku Co., Ltd., (US)

(72) Inventors: Haruya SAKAUE, Shiga (JP); Kentaro WATANABE, Shiga (JP); Manabu MIZUTANI, Osaka (JP)

(73) Assignee: Daifuku Co., Ltd., Osaka (JP)

(21) Appl. No.: 13/775,013

(22) Filed: Feb. 22, 2013

(30) Foreign Application Priority Data
Feb. 24, 2012 (JP) 2012-038076

(51) Int. Cl. G06Q 10/06

(52) U.S. Cl. CPC G06Q 10/063114
USPC 705/7.15

(57) ABSTRACT

An operation management apparatus is configured for managing a monotonous task requiring a worker to perform a prescribed action. The operation management apparatus includes a detector configured to detect an action of the worker in an area where the monotonous task is performed, a first storage unit configured to pre-register a correct action of the monotonous task to be performed by the worker, a first determination unit configured to determine whether the pre-registered correct action of the monotonous task matches an action by the worker detected by the detector; and an output unit configured to generate an output when the first determination unit determines that the pre-registered correct action of the monotonous task does not match the detected action.

### CROSS-REFERENCE TO RELATED APPLICATION

The present application claims priority from Japanese patent applications No. 2012-038076 filed on Feb. 24, 2012, the entire contents of which are hereby incorporated by reference.

### TECHNICAL FIELD

The present disclosure relates to an operation management device and a sorting system with the operation management device.

### RELATED ART

There are two types of sorting systems: assorting (classifying) systems and picking systems. An assorting system, which is a type of a sorting system, is equipment for conveying, for example, arrived articles by a work cart and sorting the articles into bays of a rack, to which distribution destinations (e.g., stores) are assigned beforehand. On the other hand, a picking system is equipment for sorting articles from a sorting rack into containers (to which distribution destinations are assigned beforehand) moving on a line. There is a picking system that is configured to move containers for collecting articles in two rows parallel to the moving direction of the line, and that has an instruction indicator for instructing to sort two articles into the two-row collection containers. This system allows increasing the number of containers to be tact-fed and improves the sorting capacity.

Many tasks are automated in a sorting system including an assorting system or a picking system, and a worker engaged in manual operations seldom has to make a decision. While this allows an unskilled worker to perform the manual operations, the manual operations may be considered to become monotonous tasks requiring the worker to perform prescribed-simple actions. Such prescribed-simple actions may result in improper work attributed to the worker's weariness and/or fatigue resulting from, and familiarity with, monotonous actions. In the sorting system, articles are manually handled immediately before being shipped to customers. Therefore, the improper work is a major problem which impacts the customers directly. Consequently, conventional sorting systems require workers to press a push-button to confirm the completion of each action of a monotonous task in order to indicate the completion of the action of the monotonous task and to prevent an occurrence of improper work.

However, it is obviously troublesome for a worker who performs the monotonous task to have to press such a push-button after each action is completed. Therefore, the worker who has become familiar with the monotonous task may not use the push-button for the originally intended purpose of confirmation, but may press the push-button before finishing a predetermined action, for example. The push-button for confirmation in the conventional sorting systems is a burden to the worker and cannot prevent an occurrence of improper work reliably.

### SUMMARY

An operation management apparatus according to one aspect of the present disclosure is configured for managing a monotonous task requiring a worker to perform a prescribed action. The operation management apparatus may includes a detector configured to detect an action of the worker in an area where the monotonous task is performed, a first storage unit configured to pre-register a correct action of the monotonous task to be performed by the worker, a first determination unit configured to determine whether the pre-registered correct action of the monotonous task matches an action by the worker detected by the detector, and an output unit configured to generate an output when the first determination unit determines that the pre-registered correct action of the monotonous task does not match the detected action.

A sorting system according to another aspect of the present disclosure includes an operation management apparatus configured to manage a monotonous task requiring a worker to perform a prescribed action. The operation management apparatus may include a detector configured to detect an action of the worker in an area where the monotonous task is performed, a first storage unit configured to pre-register a correct action of the monotonous task to be performed by the worker, a first determination unit configured to determine whether the pre-registered correct action of the monotonous task matches an action by the worker detected by the detector, and an output unit configured to generate an output when the first determination unit determines that the pre-registered correct action of the monotonous task does not match the detected action.

An operation management apparatus according to yet another aspect of the present disclosure is also configured for managing a monotonous task requiring a worker to perform a prescribed action. The operation management apparatus may include a detector configured to detect an action of the worker in an area where the monotonous task is performed, a first storage unit configured to pre-register a correct action of the monotonous task to be performed by the worker, one or more processors, when programmed by a program, to perform first determination of whether the pre-registered correct action of the monotonous task matches an action by the worker detected by the detector; and generation of an output indicating that the pre-registered correct action of the monotonous task does not match the detected action.

Additional aspects and advantages of the present disclosure will become readily apparent to those skilled in the art from the following detailed description, wherein only exemplary embodiments of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Examples of the subject matter claimed herein are illustrated in the figures of the accompanying drawings and in which reference numerals refer to similar elements and in which:

FIG. 1 is a perspective view of a label-attachment work area in a picking system with an operation management apparatus according to one embodiment of the present disclosure.

FIG. 2 is an exemplary block diagram showing the operation management apparatus.

FIGS. 3A-3D are diagrams showing exemplary actions A through E of a monotonous task performed by a worker in a work space within the label-attachment work area. FIG. 3A shows actions A and B, FIG. 3B shows action C, FIG. 3C shows action D, and FIG. 3D shows action E.

FIGS. 4A-G are diagrams showing exemplary gestures performed by the worker (each gesture is performed by one action) for providing his/her intention to the picking system. FIG. 4A shows a gesture to send an emergency stop instruction to the picking system. FIG. 4B shows a gesture to send an instruction to restart the system that has stopped in an emergency. FIG. 4C shows a gesture to send a request for replenishing a new pallet P on which articles W are placed.

FIG. 4D shows a gesture to suspend the monotonous task. FIG. 4E shows a gesture to send a request to interrupt the task. FIG. 4F shows a gesture for notification of an occurrence of a defect. FIG. 4(g) shows a gesture for notification of an occurrence of stockout.

FIG. 5 is a diagram showing an exemplary gesture performed by the worker (a gesture is performed by two actions) for providing his/her intention to the picking system (the gesture represents an instruction for a restart of the system that has stopped in an emergency).

FIGS. 6A and 6B show a front view showing a monitor of the operation management apparatus, wherein FIG. 6A shows the monitor displaying a monotonous task being performed; and FIG. 6B shows the monitor displaying an improper work warning.

FIG. 7 is a flowchart showing exemplary steps to pre-register a worker's action.

FIG. 8 is a flowchart showing exemplary steps to pre-register a state of an article.

FIG. 9 is a flowchart showing exemplary steps to be performed based on a worker's gesture.

FIG. 10 is a flowchart showing exemplary steps to output a warning based on a state of an article.

FIG. 11 is a perspective view of a work space showing an example of arranging two sensors for the task.

FIG. 12 is a perspective view of a work space showing an example of a gesture performed by two workers.

FIG. 13 is a block diagram showing exemplary hardware configuration of the operation management apparatus of the present disclosure.

### DETAILED DESCRIPTION

An example of the present disclosure is described below with reference to the drawings. One aspect of the example to be discussed is to prevent an occurrence of improper work without imposing a burden on workers.

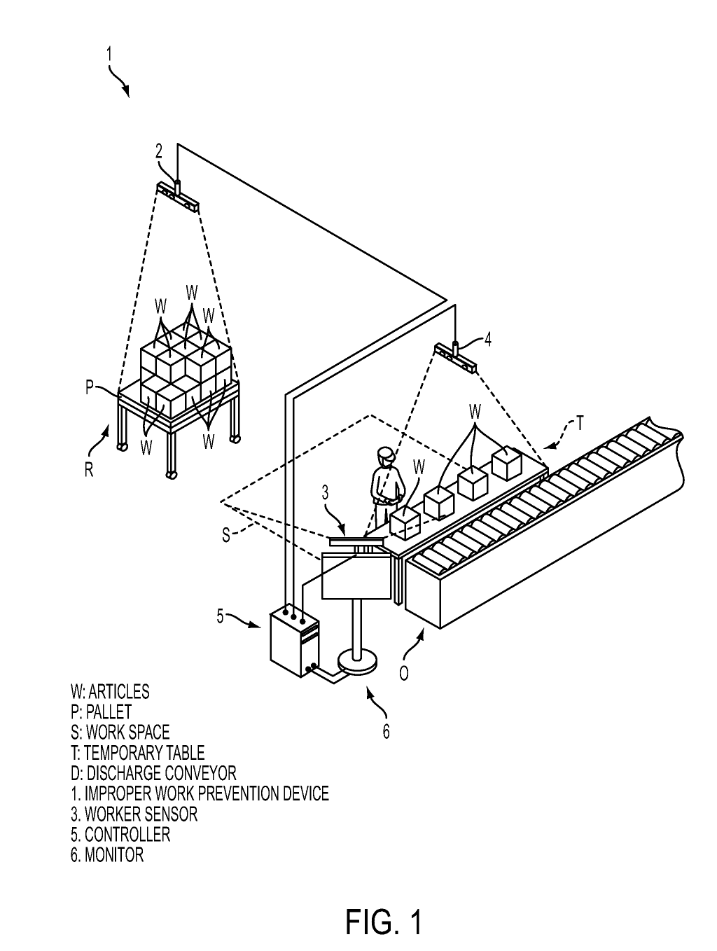

FIG. 1 is a perspective view showing an example of an operation management apparatus 1 set up in a label-attachment work area within a picking system which is an example of a sorting system.

The label-attachment work area will be explained briefly. As shown in FIG. 1, provided in the label attachment work area are a pallet P on which a number of articles W are placed, a temporary table T on which labels are attached to articles W moved from pallet P, and a discharge conveyor O for discharging articles W to which the labels have been attached. Pallet P is placed on a cart R to which a brake is applied. Temporary table T is located between pallet P and discharge conveyor O, but is rather located adjacent to discharge conveyor O. Between pallet P and temporary table T is a work space S for a worker to perform a task. The task which the worker is to perform in work space S in this example is to move articles W from pallet P to temporary table T; to attach labels to articles W on temporary table T; and to move articles W with the labels to discharge conveyor O. In this example, the task performed by the worker in work space S is defined as an example of a monotonous task. Although FIG. 1 shows an example in which pallet P is placed on cart R, pallet P may be brought near work space S intermittently using a transfer conveyor or an inclined flow-through rack.

### [Schematic Configuration of Operation Management Apparatus 1]

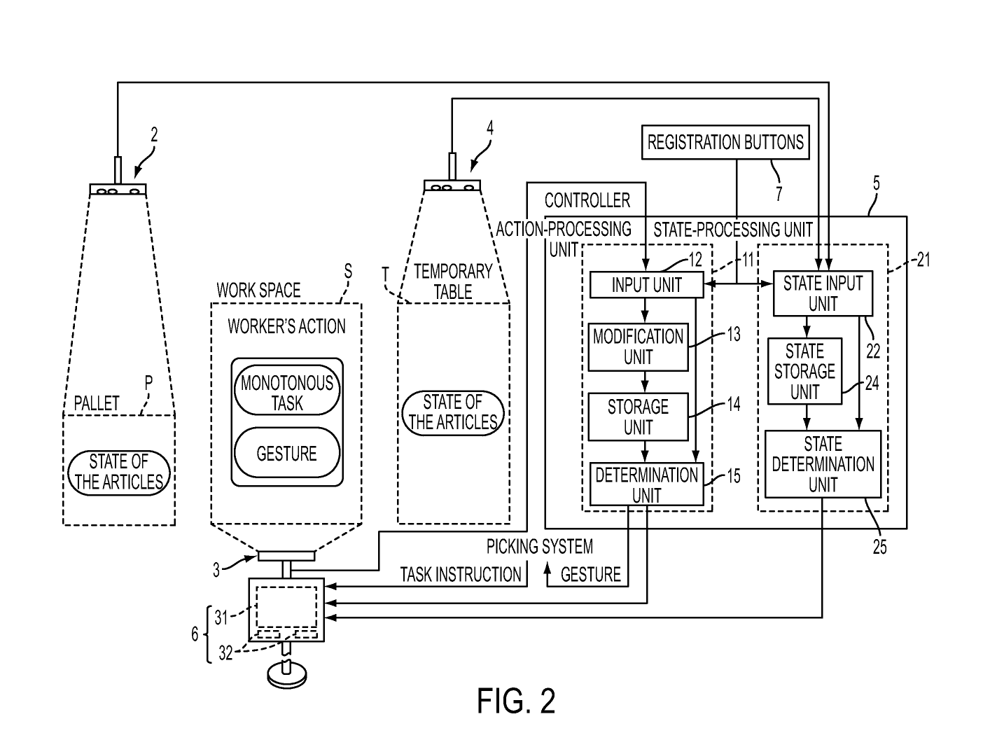

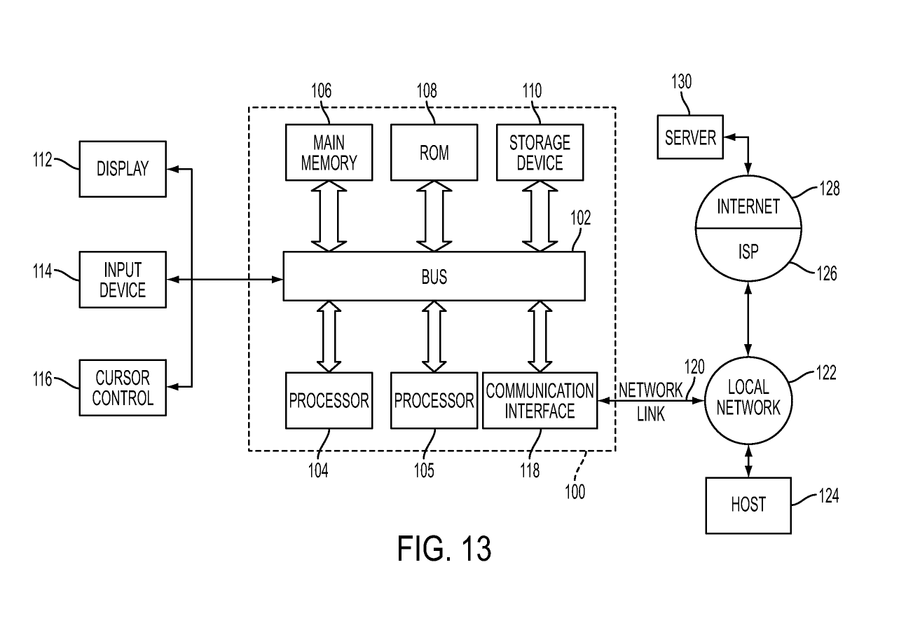

As shown in FIG. 1, operation management apparatus 1 has an upstream sensor 2 detecting a state of articles W on pallet P, a worker sensor 3 for detecting the worker's action in work space S, a downstream sensor 4 for detecting a state of articles W on temporary table T, a controller 5 (e.g., a personal computer, see FIG. 13) for determining whether the worker's action and the states of articles W detected by sensors 2, 3, and 4 are proper, and a monitor 6 for showing a determination by the controller to the worker. Also provided within the worker's reach in work space S are a task-confirmation push-button (not shown in FIG. 1) for confirming the completion of the monotonous task, a monotonous task-registration button (or switch) (not shown in FIG. 1) for pre-registering a correct action of the monotonous task, gesture-registration button (or switch) (not shown in FIG. 1) for pre-registering a correct action of a gesture to be performed by the worker (described later), and a state-registration button (or switch) (not shown in FIG. 1) for pre-registering a correct state of articles W on pallet P and temporary table T. The correct state of article W may mean that the article are not collapsed. These three registration buttons are shown as registration buttons (or switches) 7 in FIG. 2 which may be switched between ON and OFF by pressing buttons.

A generally available motion sensor may be used as worker sensor 3. The motion sensor can perform motion capture, for example, by built-in cameras or active sensors. The motion sensor can recognize the frame of the worker's body such as his/her head, torso, or limbs) to detect an action performed by the worker. KINECT® (a motion sensing input device by Microsoft Corporation) may be one of examples of the motion sensor. On the other hand, upstream sensor 2 and downstream sensor 4 may be any of those that can recognize a three-dimensional location of articles W, such as a camera with a depth sensor or a motion sensor. In this example, motion sensors are used as upstream sensor 2 and downstream sensor 4, respectively.

### [Worker's Actions]

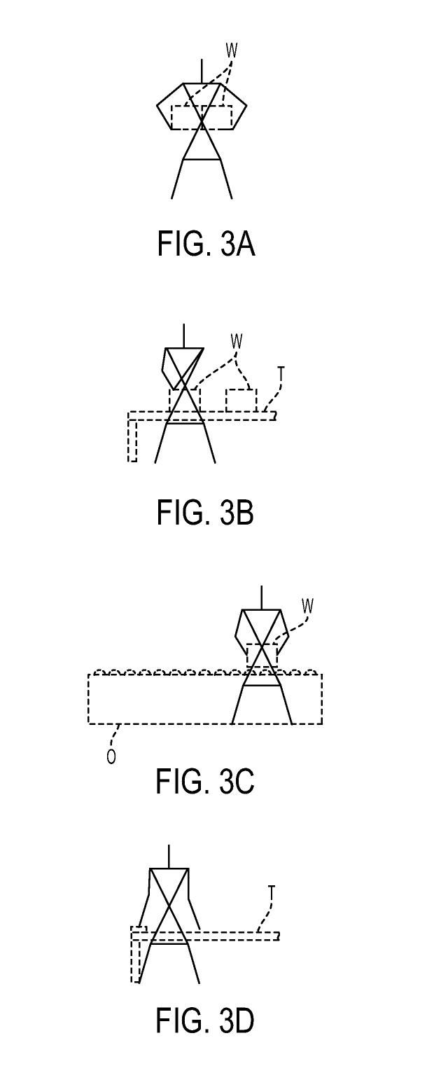

As shown in FIG. 2, the worker's actions at work space S include a monotonous task and a gesture. The monotonous task includes a series of actions by the worker. For example, as shown in FIG. 3, the monotonous task includes action A to move two articles W at a time from pallet P to temporary table T (FIG. 3A), action B to additionally move two articles W at a time from pallet P to temporary table T (FIG. 3A), action C to attach labels to four articles W on temporary table T, respectively (FIG. 3B), action D to move four articles W with the labels to discharge conveyor O (FIG. 3C), and action E to press the task-confirmation push-button to confirm the completion of the series of action for one task (FIG. 3D) (as discussed below, for example, action E may be performed by the worker's gesture showing as if he pushed the task-confirmation push-button, with the button remained on). As long as the same result can be obtained, multiple actions of a monotonous task can be defined as one action, the order of the multiple actions can be shuffled, or one action can be divided into multiple actions. For example, actions A and B may be combined into one action A′ to move four articles W at a time from pallet P to temporary table T. The order of actions D and E may be reversed. Further, action A (B) may be divided into two: action a1 (b1) to move one article W at a time from pallet P to temporary table T and move a2 (b2) to additionally move one article W at a time from pallet P to temporary table T. As long as the same result, i.e., four articles W with labels are discharged, can be obtained, the series of actions for the monotonous task can be modified (combined, replaced, or divided).

The gesture may be expressed by one action or a series of actions (e.g., a small number of actions). The gesture in this example can provide an instruction of emergency stop to the picking system, an instruction to restart the system that has stopped in an emergency, a request for replenishing a new pallet P having articles W, an instruction to suspend a monotonous task, a request to interrupt a monotonous task, a notification of an occurrence of a defect, and a notification of an occurrence of a stockout. Such gestures (actions) may be recognized by controller 5 preferably in a clearly distinguishable manner from actions of the monotonous task. That is, actions for gestures in this example may substantially be different from the actions of the monotonous task.

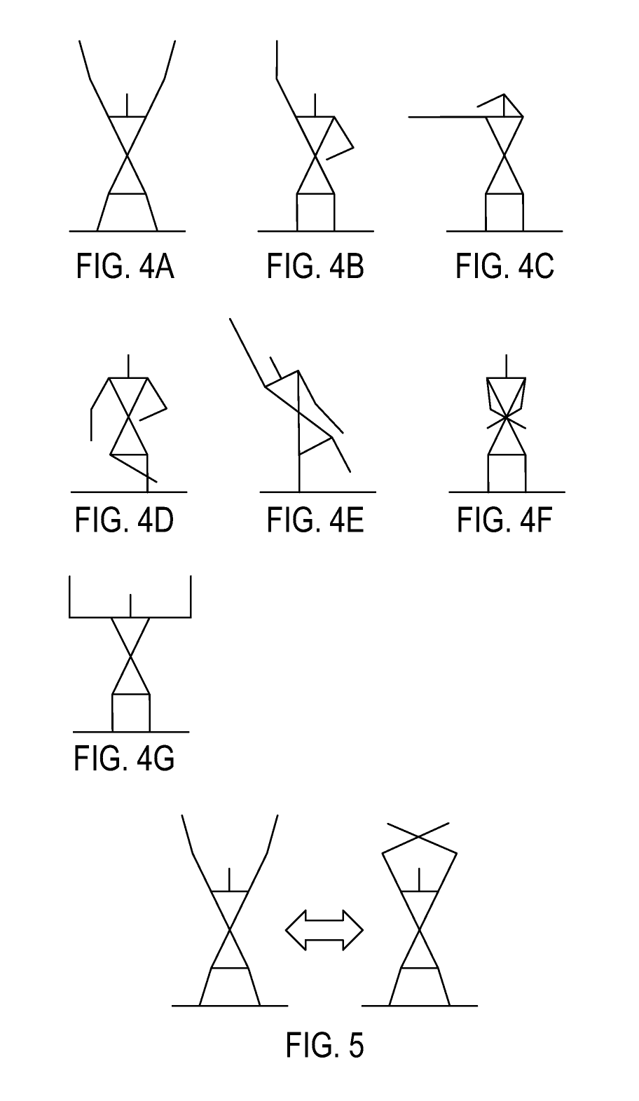

FIG. 4A-4G show examples of the gestures expressed by one action: spreading both arms and legs wide to form a letter X with the body for instructing the picking system to stop in an emergency (FIG. 4A); placing the left hand on the waist and raising the right hand upward for instructing to restart the system that has stopped in an emergency (FIG. 4B); placing the left hand behind the head and extending the right arm horizontally toward the right for requesting to replenish a new pallet P (FIG. 4C); placing the left hand on the waist and bringing the right foot in front of the left knee for an instruction to suspend a task (FIG. 4D); lifting the left foot and raising the right hand toward the upper-right while leaning the body toward the right for requesting to interrupt a task (FIG. 4E); crossing both arms in front of the abdomen for notifying an occurrence of a defect (FIG. 4F); and spreading both arms to left and right and bend them upright at the same time for notifying an occurrence of a stockout (FIG. 4G). Also, as shown in FIG. 5, a gesture can be done by two actions which alternately repeat the forming of letter X by spreading both arms and both legs (FIG. 5 on the left) and the crossing of both arms over the head while keeping both legs spread for instructing to suspend a task (FIG. 5 on the right).

### [Controller 5]

As shown in FIG. 2, controller 5 may include an action-processing unit 11 for processing information on actions by the worker, and a state-processing unit 21 for processing information on states of articles W on pallet P and temporary table T.

Action-processing unit 11 may include an input unit 12 for inputting the worker's action detected by worker sensor 3, a modification unit 13 for modifying the worker's action from input unit 12 as appropriate, a storage unit 14 for pre-registering the worker's action, and a determination unit 15 for determining whether the pre-registered action in storage unit 14 matches an action actually performed by the worker inputted through input unit 12.

Input unit 12 may divide information on the worker's series of actions from worker sensor 3 into information on each of the actions. The divided information may be sent to modification unit 13 for pre-registration when the monotonous task-registration button or the gesture registration button is ON, or sent to modification unit 15 for detecting improper work when both of these registration buttons are OFF. In short, input unit 12 may be configured to send the information from worker's sensor 3 for the pre-registration or the improper work detection.

Modification unit 13 may be configured to modify the action of the monotonous task for the pre-registration to a different form of the action. The action before modification and the action after modification can obtain the same result, i.e., in this example, four articles W with labels are discharged through discharge conveyer O. In other words, when the action of the monotonous task comprising actions A through E (FIG. 3) is inputted, modification unit 13 may combine actions A and B to create action A′, switch an order of actions D and E, or break down motion A (B) to action a1 (b1) and action a2 (b2) (these modifications are discussed above in relation to FIGS. 3A-3D.

Storage unit 14 pre-registers the worker's action of a monotonous task detected by worker sensor 3 before and after modification unit 13 modifies the information on the action, and pre-registers the worker's action of a gesture detected by worker sensor 3 without modifying it by modification unit 13. Storage unit 14 is capable of pre-registering multiple actions per one type of action, thereby providing the pre-registered action with a range. For example, for an action of moving four articles W from pallet P to temporary table T, the first action that moves only one article W each time in order to move four articles W and the second action that moves four articles W at one time, can be pre-registered.

Determination unit 15 can determine whether the pre-registered action of the monotonous task matches an actually performed worker's action from input unit 12. When it is determined that the above two actions do not match with each other, determination unit 15 further determines whether a pre-registered gesture matches the actually performed worker's action from input unit 12. When these actions match with each other, determination unit 15 may send information on the gesture to the picking system, and if these action do not match with each other, sends an output information (improper work) to monitor 6.

State-processing unit 21 may include a state input unit 22 to which states of articles W detected by upstream sensor 2 and downstream sensor 4 are inputted, a state storage unit 24 for pre-registering the states of articles W, and a state determination unit 25 for determining whether the pre-registered state of articles W matches inputted state of articles W.

State input unit 22 sends the detected states of articles W from upstream sensor 2 and downstream sensor 4 to state storage unit 24 for an pre-registration when the state registration button is ON, and sends the detected states of articles W to state determination unit 25 for detecting collapsing when the state registration button is OFF. That is, state input unit 22 sorts the information from upstream sensor 2 and downstream sensor 4 for pre-registration or for detecting collapsing.

State storage unit 24 may be capable of pre-registering multiple states per one type of state in a similar manner as storage unit 14, thereby providing the pre-registered state with a range.

State determination unit 25 may determine whether the pre-registered state of articles W matches actually detected state of articles W from upstream sensor 2 and downstream sensor 4 for detecting collapsing, and sends an output information (warning) to monitor 6 if the states do not match with each other.

### [Monitor 6]

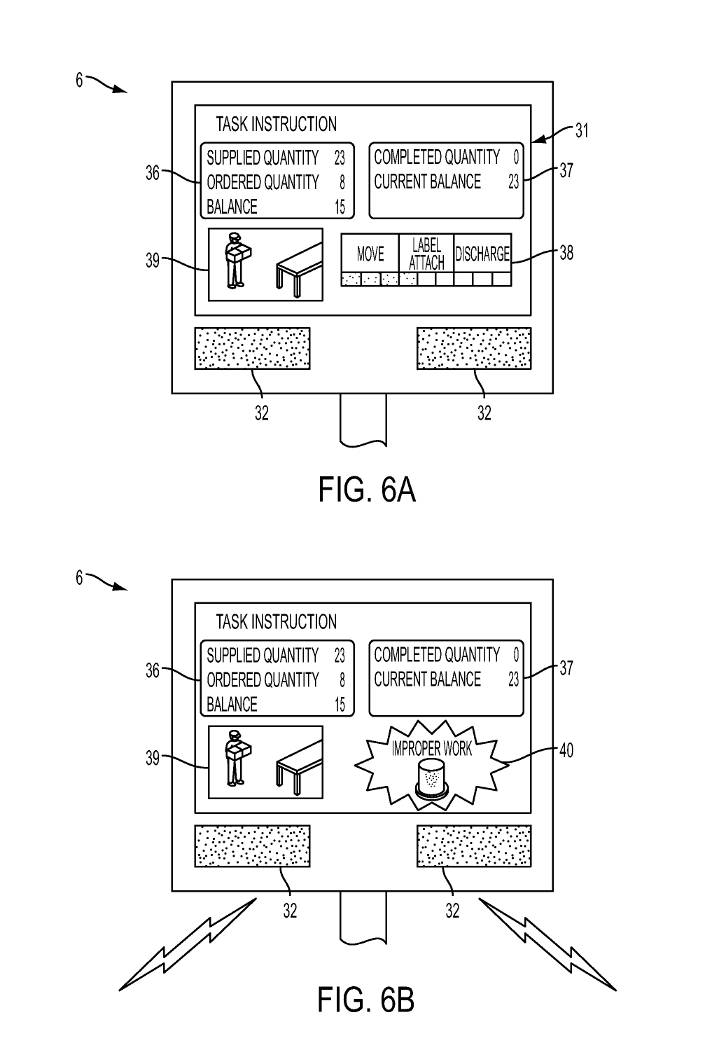

Monitor 6 may have a screen 31 and speakers 32 as shown in FIGS. 2, 6A, and 6B. Monitor 6 may be arranged so that screen 31 faces the worker in work space S, as shown in FIG. 1.

Screen 31 may display that a pre-registration is being performed (not shown) during a pre-registration of the worker's action or a state of articles W, and display a task instruction 36 from the picking system to the worker in work space S, current task status 37, task progress 38, and a moving image 39 of a pre-registered correct action of the monotonous task, as shown in FIG. 6A. Task instruction 36 may include a supplied quantity which is a quantity of articles W on initial pallet P, an ordered quantity which is a quantity of articles W to be discharged, and a balance after subtracting the ordered quantity from the supplied quantity. Task status 37 may include a completed quantity which is a quantity of articles W actually discharged by the worker, and a current balance after subtracting the completed quantity from the supplied quantity. Further, task progress 38 may include a text representation of each motion constituting the monotonous task, and a scale which lights up completed motions. Screen 31 can display an image 40 to notify the worker of an occurrence of improper work as shown in FIG. 6B when an output is sent from determination unit 15 of controller 5 to monitor 6. Screen 31 can display an image to notify of the worker of potential collapsing (although not shown), when an output (warning) is sent from state determination unit 25 of controller 5 to monitor 6.

Speakers 32 can notify the worker of what is displayed on screen 31 with a voice as appropriate. Speakers 32 may generate a warning sound to notify the worker of improper work or potential collapsing as appropriate as shown in FIG. 6B when an output (warning) is sent from controller 5 to monitor 6.

### [Using Operation Management Apparatus 1]

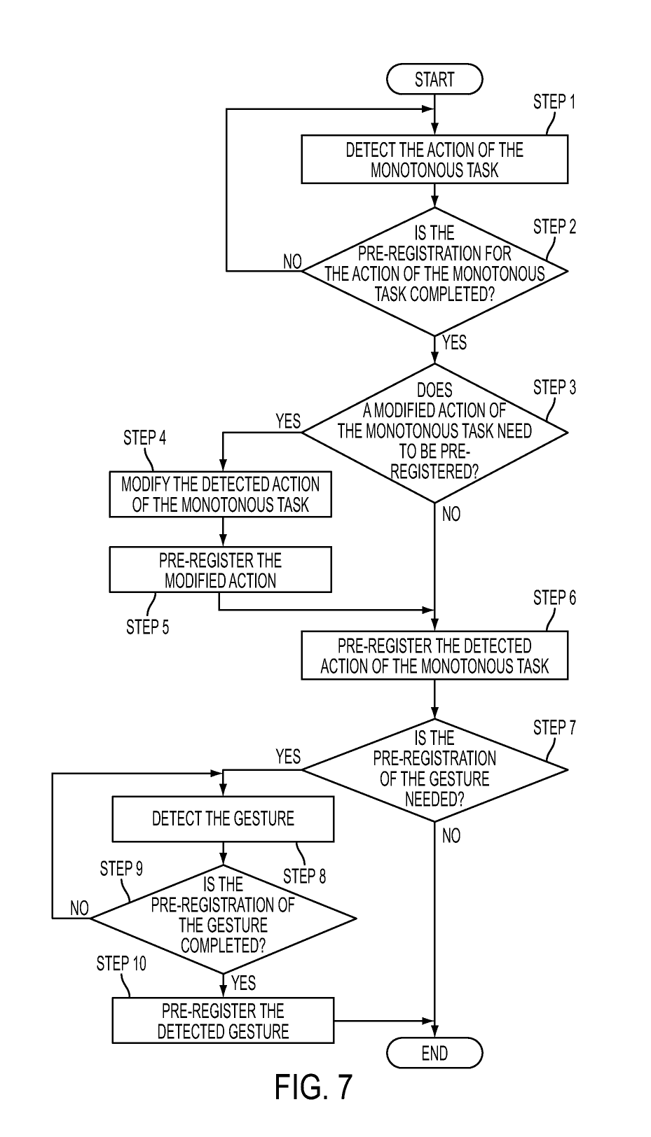

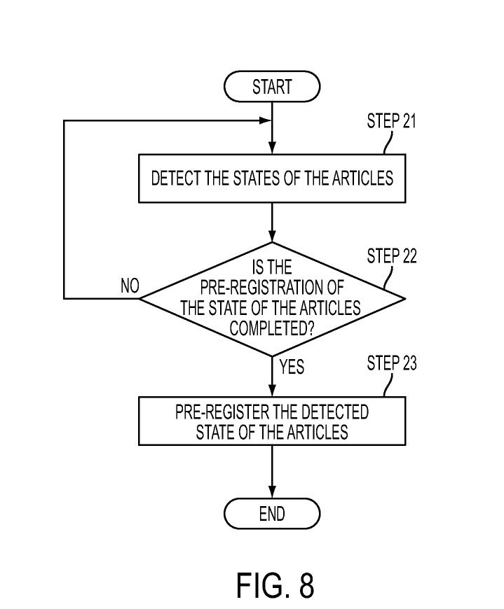

Pre-registrations of the worker's action and the state of articles W will be explained with reference to FIGS. 7 and 8. FIG. 7 exemplarily shows the pre-registration of the worker's actions. When the monotonous task-registration button is turned ON, worker sensor 3 detects the worker performing a series of correct actions of the monotonous task in work space S for pre-registration (STEP 1). The simple task-registration button is turned OFF when the correct actions of the monotonous task are completed (STEP 2). Information regarding the correct actions of the monotonous task detected by worker sensor 3 may be divided to pieces of the information corresponding to the respective actions, which are sent to modification unit 13 for a pre-registration. If needed (STEP 3), the information of the detected correct actions may be modified to be information which can obtain the same result as the information of the detected correct actions (STEP 4). The modified information may then be pre-registered (STEP 5) and the information before the modification may also be pre-registered (STEP 6).

If the gesture registration button is then turned ON (STEP 7) and the worker performs a gesture in work space S in order to express the worker's intention, the gesture are detected by worker sensor 3 (STEP 8). The action-registration button is turned OFF when the correct gesture is completed (STEP 9). Information regarding the correct gesture detected by worker sensor 3 is sent to storage unit 14 as information for the gesture, and is pre-registered (STEP 10). It may also be possible to not press the gesture registration button and not pre-register the correct gesture.

Next, a pre-registration of states of articles W will be explained with reference to FIG. 8. When articles W are arranged in correct states (the states in which articles W do not collapse) on pallet P and temporary table T, and the state-registration button is turned ON, the states of these articles W are detected by upstream sensor 2 and downstream sensor 4 (STEP 21). The state-registration button is turned OFF when upstream sensor 2 and downstream sensor 4 finish detecting articles W (STEP 22). Information on the correct states of articles W detected by upstream sensor 2 and downstream sensor 4 is sent to state storage unit 24 via state input unit 22 for pre-registration (STEP 23).

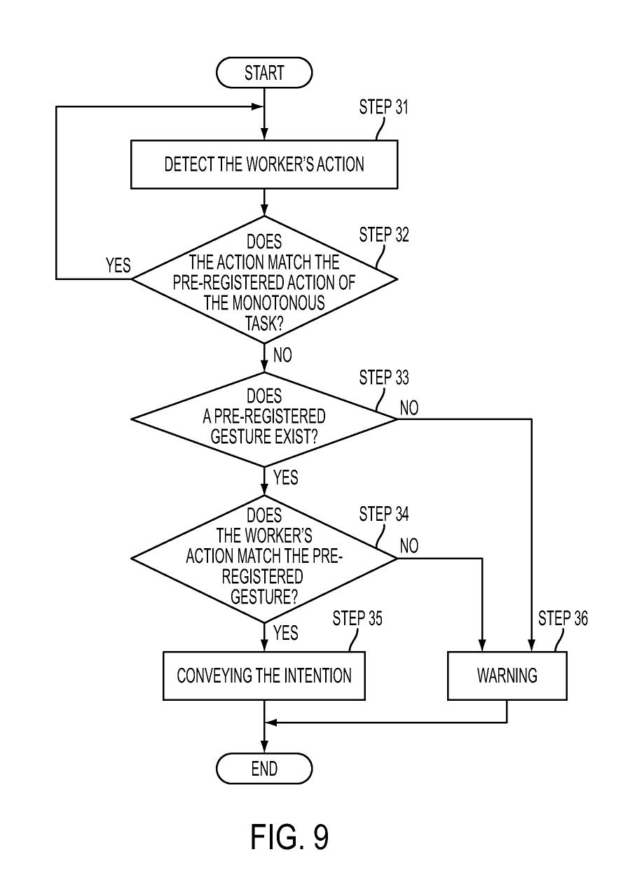

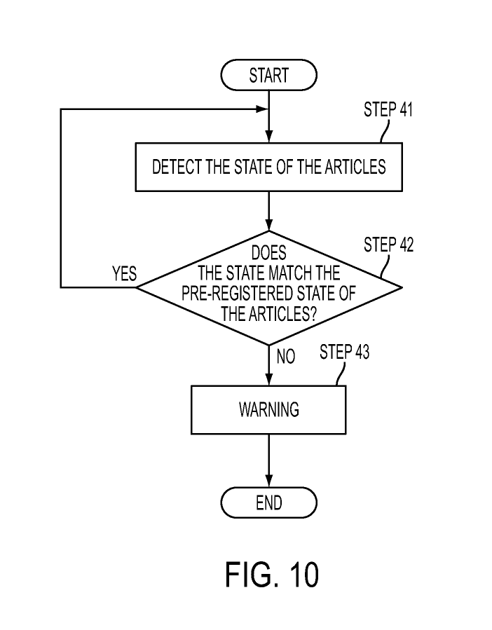

A method of using operation management apparatus 1 after the pre-registrations are done will be explained with reference to FIGS. 9 and 10.

In work space S, the worker performs an action of a monotonous task as well as a gesture. The worker's such action is detected by worker sensor 3 (STEP 31). Subsequently, the determination is made whether the pre-registered action of the monotonous task matches the action that are detected by worker sensor 3 (STEP 32). When it is determined that these actions do not match with each other, if the gesture is pre-registered (STEP 33) and if the pre-registered gesture matches the worker's action detected by worker sensor 3 (STEP 34), the information on the gesture expressing the worker's intention is sent to the picking system (STEP 35), otherwise output information (warning) on improper work is sent to monitor 6 (STEP 36).

On the other hand, the states of articles W change on pallet P and on temporary table T when articles W are transferred from pallet P to temporary table T as a result of the monotonous task by the worker. In FIG. 10, such states of articles W can be detected by upstream sensor 2 and downstream sensor 4 (STEP 41). It is then determined whether the pre-registered states of articles W match the states of articles W detected by upstream sensor 2 and downstream sensor 4 (STEP 42). Output (warning) information may be sent to monitor 6 if it is determined that both states do not match (STEP 43).

Thus, according to operation management apparatus 1 of one example of the present disclosure, determination can be made whether the worker's action of the monotonous task detected by worker sensor 3 is correct, thereby preventing an occurrence of improper work reliably, eliminating a task to confirm a completion of the actions, and reducing the burden on the worker.

The worker can provide his/her intention to the picking system just by performing a gesture, for example, at work space S so that the burden on the worker can be further reduced. The action of a gesture is significantly different from the action of a monotonous task. Therefore, an incorrect identification between the gesture and the monotonous task can be prevented, and the reliability of operation management apparatus 1 can be improved.

Further, since appropriately modified actions of the monotonous task can be pre-registered, the actions of the monotonous task by the worker will not be detected as an error even when the worker's actions are slightly different as long as such a difference is within an acceptable range. This can allow the worker to perform the monotonous task with some flexibility.

Additionally, since multiple actions (i.e., variations) for one monotonous task can be pre-registered in storage unit 14, a determination by determination unit 15 may become reliable, which allows the worker to perform the monotonous task with even more flexibility.

Moreover, collapsing of articles W can be detected by upstream sensor 2, downstream sensor 4, and state-processing unit 21. Collapsing of articles W can thus be prevented while the simple task is being performed.

The above-discussed example shows that one worker sensor 3 is arranged to detect the worker's action performed in work space S as shown in FIG. 1. The present disclosure is not limited thereto and a plurality of worker sensors may be arranged in addition to worker sensor 3.

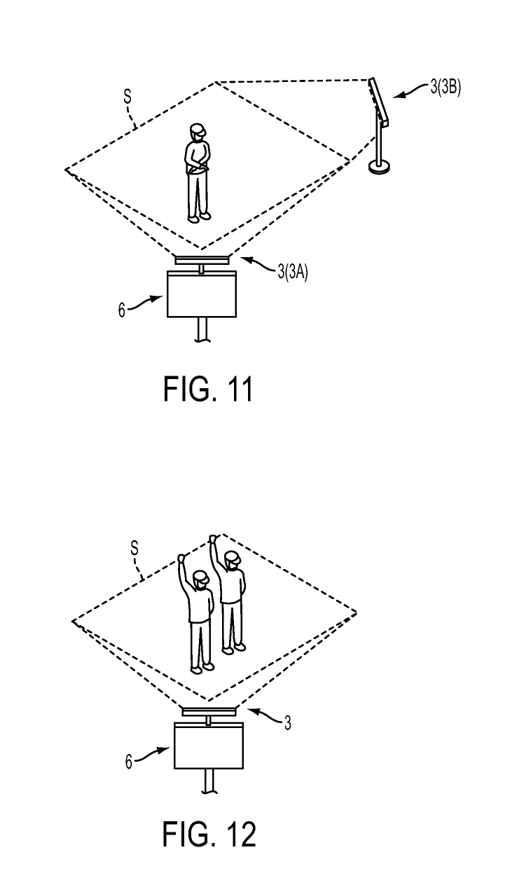

FIG. 11 shows an example in which two worker sensors 3A and 3B are arranged. This example assumes two cases with respect to gestures: the first case is that the worker's intention must be conveyed reliably and the second case is that the worker's intention must be conveyed urgently. In the first case, determination unit 15 can determine if a pre-registered gesture matches both actions detected by worker sensors 3A and 3B (logical product: AND) to reduce the probability of conveying an incorrect intention of the worker. This may be effective when an intention must be conveyed reliably (for example, replenishing a new pallet P is required). In the second case, determination unit 15 can determine if a pre-registered action gesture matches an action detected by one of worker sensors 3A and 3B (logical sum: OR) to reduce the probability of failing to convey the worker's intention. This may be effective when an intention must be conveyed urgently (for example, instructing the picking system to stop in an emergency is required).

Although the example shows a gesture performed by one worker for expressing his/her intention, the present disclosure is not limited thereto and a gesture may be performed by two or more workers. FIG. 12 shows an example of a gesture to be performed by two workers. Because an intention can be expressed by more than one worker, the probability of expressing an incorrect intention can be reduced sufficiently. This may be effective when an intention must be conveyed even more reliably (restoring the system is required, for example).

The above-discussed example describes that worker sensor 3 actually detects the worker's actions for pre-registering correct actions of a monotonous task and a gesture of expressing an intention. Instead, information to be pre-registered may be input to the system in the form of, for example, text data.

Although the above-discussed example explains operation management apparatus 1 set up in the label attachment work area of the picking system, the present disclosure is not limited to the label attachment work area and the operation management apparatus can be set up in a picking work area. In this case, the action of attaching a label on article W in the above example may be replaced by an action of putting article W in a collection container, and the action of transferring article W to the discharge conveyor O may be replaced by an action of transferring a collection container to the discharge conveyor O.

Although the above example describes a picking system, the present disclosure may address another sorting system such as an assorting system. Of course, the present disclosure is not limited to a sorting system, but the above example can be applied, for example, to a product assembly plant, a merchandise inspection facility, and a distribution center. A monotonous task is not limited to a scheme using pallet P, temporary table T, and discharge conveyor O described in the above-discussed example, but any scheme using, for example, a picking cart, a tray, or a conveyor zone, rather than a collection container, can be used as long as the task requires a prescribed simple action to be performed. In other words, operational management apparatus 1 of the present disclosure may be provided in any work area where a worker performs a prescribed simple action to complete a task.

Although monitor 6 is an example of an output unit in the above example, the output unit is not limited thereto and may be a fixed type chime, a buzzer, a rotation indicator lamp, a small buzzer for a worker to carry, or any other means to warn a worker. The output unit is not limited to such an independent product and can be integrated inside controller 5.

Although the above example is intended for one worker, this is simply one example and the present disclosure may be applicable to multiple workers. In this case, however, worker sensor 3 has a capability of capturing the multiple workers' actions.

Controlling the quantity of articles W is not described in the above example. However, controller 5 may control the quantity of articles W. In this case, controller 5 can recognize the number of tiers of articles W and the quantity in each tier based on the states of articles W detected by upstream sensor 2 and downstream sensor 4 to calculate and save the quantity of articles W on pallet P and temporary table T. Controller 5 also can calculate and save the quantity of articles W that are discharged based on the frequency of actions for a monotonous task detected by the worker sensor 3, thereby controlling the quantity of articles W.

Although the above-discussed example describes operation management apparatus 1 that also detects collapsing of articles W, operation management apparatus 1 may not necessarily have such an function. In this case, the operation management apparatus can be configured without upstream sensor 2 and downstream sensor 4 as well as state-processing unit 21.

FIG. 13 is a block diagram that exemplarily illustrates computer system 100 which can implement the disclosed process shown in, for example, FIGS. 7-10. Computer system 100, which can be controller 5 shown in FIGS. 1 and 2, includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a liquid crystal display, which is monitor 6 shown in FIG. 1. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane. A touch panel (screen) display may also be used as an input device.

According to one embodiment of the present disclosure, the disclosed process may be performed by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. One or more processors in a multi-processing arrangement may also be employed to execute the sequences of instructions contained in main memory 106 (see processor 105). In alternative embodiments, hard-wired circuitry may be used in place of or in combination with software instructions to implement the invention. Thus, embodiments of the disclosure are not limited to any specific combination of hardware circuitry and software.

The term “computer-readable medium” as used herein refers to any medium that participates in providing instructions to processor 104 for execution. Such a medium may take many forms, including but not limited to, non-volatile media, and volatile media. Non-volatile media include, for example, optical or magnetic disks, such as storage device 110. Volatile media include dynamic memory, such as main memory 106. Common forms of computer-readable media include, for example, a hard disk, any other magnetic medium, a CD-ROM, DVD, any other optical medium, a RAM, a PROM, and EPROM, a FLASH-EPROM, any other memory chip or cartridge, or any other medium from which a computer can read.

Various forms of computer readable media may be involved in carrying one or more sequences of one or more instructions to processor 104 for execution. For example, the instructions may initially be borne on a magnetic disk of a remote computer. The remote computer can load the instructions into its dynamic memory and send the instructions over a network. Computer system 100 can receive the data. Bus 102 carries the data to main memory 106, from which processor 104 retrieves and executes the instructions. The instructions received by main memory 106 may optionally be stored on storage device 110 either before or after execution by processor 104.

Computer system 100 also preferably includes a communication interface 118 coupled to bus 102. Communication interface 118 provides a two-way data communication coupling to a network link 120 that is connected to a local network 122. For example, communication interface 118 may be a local area network (LAN) card to provide a data communication connection to a compatible LAN. Wireless links may also be implemented.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the Internet 128.

Computer system 100 can send messages and receive data, including program code, through the network(s), network link 120, and communication interface 118. In the Internet example, a server 130 might transmit a requested code for an application program through Internet 128, ISP 126, local network 122 and communication interface 118. In accordance with the present disclosure, one such downloaded application may provide for the disclosed process of the example. The received code may be executed by processor 104 as it is received, and/or stored in storage device 110, or other non-volatile storage for later execution.

Having described embodiments, it is noted that modifications and variations can be made by person skilled in the art in light of the above teachings. It is therefore to be understood that changes may be made in the particular embodiments disclosed that are within the scope and sprit of the disclosure as defined by the appended claims and equivalents.

1. An operation management apparatus for managing a monotonous task requiring a worker to perform a prescribed action, the operation management apparatus comprising:
a detector configured to detect an action of the worker in an area where the monotonous task is performed;
a first storage unit configured to pre-register a correct action of the monotonous task to be performed by the worker;
a first determination unit configured to determine whether the pre-registered correct action of the monotonous task matches an action by the worker detected by the detector; and
an output unit configured to generate an output when the first determination unit determines that the pre-registered correct action of the monotonous task does not match the detected action.

2. The operation management apparatus according to claim 1, wherein:
the first storage unit is configured to pre-register a correct action of a gesture performed by the worker to express his/her intention,
the first determination unit is configured to determine whether the pre-registered correct action of the gesture matches an action performed by the worker, and
the output unit is configured to generate an output when the first determination unit determines that the pre-registered correct action of the gesture matches the detected action.

3. The operation management apparatus according to claim 1, wherein the correct action of the monotonous task includes multiple actions to complete the monotonous task, an order of the multiple action being variable,
the operation management apparatus further comprising a modification unit configured to modify the multiple actions by which the order of the multiple actions are varied, wherein
the first storage unit is configured to pre-register the modified multiple actions of the monotonous task.

4. The operation management apparatus according to claim 1, wherein the correct action of the monotonous task includes multiple actions to complete the monotonous task, at least a part of the multiple actions being combinable to be one action,
the operation management apparatus further comprising a modification unit configured to modify the multiple actions by which at least the part of the multiple actions are combined to be one action, wherein
the first storage unit is configured to pre-register the modified multiple actions of the monotonous task.

5. The operation management apparatus according to claim 2, wherein the correct action of the gesture includes multiple actions to express the intention of the worker, an order of the multiple action being variable,
the operation management apparatus further comprising a modification unit configured to modify the multiple actions by which the order of the multiple actions are varied, wherein
the first storage unit is configured to pre-register the modified multiple actions of the gesture.

6. The operation management apparatus according to claim 2, wherein the correct action of the gesture includes multiple actions to express the intention of the worker, at least a part of the multiple actions being combinable to be one action,
the operation management apparatus further comprising a modification unit configured to modify the multiple actions by which at least the part of the multiple actions are combined to be one action, wherein
the first storage unit is configured to pre-register the modified multiple actions of the gesture.

7. The operation management apparatus according to claim 1, wherein the first storage unit is configured to pre-register multiple correct actions as the correct action of the monotonous task performed by the worker.

8. The operation management apparatus according to claim 2, wherein the first storage unit is configured to pre-register multiple correct actions as the correct action of the gesture performed by the worker.

9. The operation management apparatus according to claim 1, wherein
the monotonous task is performed with respect to an article, and
the detector includes:
a first detector configured to detect a state of the article before the monotonous task with respect to the article is performed, and
a second detector configured to detect a state of the article after the monotonous task with respect to the article is performed,
the operation management apparatus further comprising:
a second storage unit configured to pre-register correct states of the articles before and after the monotonous task is performed; and
a second determination unit configured to determine whether the pre-registered states of the articles in the second storage unit match states of articles detected by the first and second detectors, wherein
the output unit is configured to generate an output when the second determination unit determines that the pre-registered states of the articles registered in the second storage unit match the states of articles detected by the first and second detectors.

10. The operation management apparatus according to claim 1, wherein the detector includes a plurality of motion sensors.

11. The operation management apparatus according to claim 1, wherein the detector is configured to detect multiple workers' actions at one time.

12. A sorting system with an operation management apparatus, the operation management apparatus configured to manage a monotonous task requiring a worker to perform a prescribed action, wherein the operation management apparatus comprises:
a detector configured to detect an action of the worker in an area where the monotonous task is performed;
a first storage unit configured to pre-register a correct action of the monotonous task to be performed by the worker;
a first determination unit configured to determine whether the pre-registered correct action of the monotonous task matches an action by the worker detected by the detector; and
an output unit configured to generate an output when the first determination unit determines that the pre-registered correct action of the monotonous task does not match the detected action.

13. The sorting system according to claim 12, wherein:
the first storage unit is configured to pre-register a correct action of a gesture performed by the worker to express his/her intention,
the first determination unit is configured to determine whether the pre-registered correct action of the gesture matches an action performed by the worker, and
the output unit is configured to generate an output when the first determination unit determines that the pre-registered correct action of the gesture matches the detected action.

14. An operation management apparatus for managing a monotonous task requiring a worker to perform a prescribed action, the operation management apparatus comprising:
a detector configured to detect an action of the worker in an area where the monotonous task is performed;
a first storage unit configured to pre-register a correct action of the monotonous task to be performed by the worker;
one or more processors, when programmed by a program, to perform:
first determination of whether the pre-registered correct action of the monotonous task matches an action by the worker detected by the detector; and
generation of an output indicating that the pre-registered correct action of the monotonous task does not match the detected action.

15. The operation management apparatus according to claim 14, wherein:
the first storage unit is configured to pre-register a correct action of a gesture performed by the worker to express his/her intention, and
the one or more processers further perform
second determination of whether the pre-registered correct action of the gesture matches an action performed by the worker, and
generation of an output indicating that the pre-registered correct action of the gesture matches the detected action.

16. The operation management apparatus according to claim 14, wherein the correct action of the monotonous task includes multiple actions to complete the monotonous task, an order of the multiple action being variable,
the one or more processors further perform modification of the multiple actions by which the order of the multiple actions are varied, wherein
the first storage unit is configured to pre-register the modified multiple actions of the monotonous task.

17. The operation management apparatus according to claim 14, wherein the correct action of the monotonous task includes multiple actions to complete the monotonous task, at least a part of the multiple actions being combinable to be one action,
the one or more processors further perform modification of the multiple actions by which at least the part of the multiple actions are combined to be one action, wherein
the first storage unit is configured to pre-register the modified multiple actions of the monotonous task.

18. The operation management apparatus according to claim 15, wherein the correct action of the gesture includes multiple actions to express the intention of the worker, an order of the multiple action being variable,
the one or more processors further perform modification of the multiple actions by which the order of the multiple actions are varied, wherein
the first storage unit is configured to pre-register the modified multiple actions of the gesture.

19. The operation management apparatus according to claim 15, wherein the correct action of the gesture includes multiple actions to express the intention of the worker, at least a part of the multiple actions being combinable to be one action,
the one or more processors further perform modification of the multiple actions by which at least the part of the multiple actions are combined to be one action, wherein
the first storage unit is configured to pre-register the modified multiple actions of the gesture.
